(19) United States
(12) Patent Application Publication
(10) Pub. No.: US 2011/0167013 A1
(43) Pub. Date: Jul. 7, 2011

(54) ONLINE CLASSROOM QUALITY CONTROL SYSTEM AND METHOD

(76) Inventors: Laura Pogue, Troy, MI (US); Kimberly L. Rub, Washington Township, MI (US)

(21) Appl. No.: 12/990,936

(22) PCT Filed: Mar. 12, 2009
(86) PCT No.: PCT/US09/01576

§ 371 Date: Mar. 24, 2011

Related U.S. Application Data
(60) Provisional application No. 61/070,567, filed on Mar. 21, 2008.

(51) Int. Cl. G06Q 50/00

(52) U.S. Cl. 705/326

(57) ABSTRACT

A method of continuously improving an online course taught by an educational institution over a computer generated medium to a plurality of locations is disclosed. A minimum criteria is established and used to determine the quality of the online course taught through the computer generated medium. The online course sessions are monitored from a remote location through the computer generated medium at predetermined periodic intervals. Electronic reports are generated at the remote location and are provided to the educational institution during the online course via the electronic medium enabling the educational institution to make real time adjustments to the online course before the online course ends for improving the quality of the online course.

### RELATED APPLICATIONS

This is a non-provisional application that claims priority to a provisional application Ser. No. 61/070,567 filed on Mar. 21, 2008 and incorporated herewith by reference in its entirety.

### FIELD OF THE INVENTION

The present invention is directed generally to online educational and training systems and methods for evaluating the quality of an online course.

### BACKGROUND OF THE INVENTION

The online education industry is a relatively new way to deliver education. In order to stay competitive with the growing number of competitors entering the online education market, institutions offering online courses must do something to measure, maintain and improve the quality of the online course. Institutions offering online courses must be creative in their methods and products offered to maintain and ensure a high-level of online classroom quality and to stay competitive with the growing number of competitors within the online education market.

Today numerous prior art educational institutions worldwide offer electronic, i.e. online based, educational courses. One or more online instructors may teach a section of an online course for a group of online students. The success of the online educational institution depends upon the effectiveness of the online instructor in promoting online student participation in the online course and interaction among the online students and the online instructor in a manner that creates an educational learning environment. In a traditional university, a professor may be evaluated based on the results of online student surveys completed at the end of an online course. The professor may also be evaluated based on the quantity of publications that the professor generates, the amount of grants for research that the professor successfully obtains for the university, and the significance of any research that the professor undertakes for the university's benefit.

Currently, there is no standardized process existing in the online classroom marketplace, making use of supportive reporting documents to serve this need in the online classroom marketplace. An industry desire has been expressed for an online classroom quality control process that provides real-time information and feedback to the institution.

The art is replete with prior art systems and methods on online teaching. One of these prior art systems is based on a complaint filed by online students or review the online student end-of-course surveys. Neither is a proactive approach to managing the quality of an online classroom. Known methods only perform an end of course survey and issue a report after it is too late to make online course improvements. Online student complaints are not necessarily related to the online classroom quality, itself, while end-of-course surveys are not entirely focused on the online classroom quality, either, and may also address many other aspects of an online course, including books, topics, instructors, classmates, etc.

Numerous other prior art systems and methods teach methods of evaluating performance of an online instructor of an electronic or online course, wherein the performance data on the online instructor is monitored as the online instructor and online students participating in the online course. The monitored performance data is then stored in a database. The system also determines an evaluative factor of the online instructor's response time based on the performance data. The online instructor response time is based on a time period measured from an online student communication to an online instructor response. As both the performance data and an evaluative factor are evaluated, the system determines whether a qualifying threshold is met in order to determine whether the online instructor is qualified for a performance-based compensation. The time period measured from the online student communication to the online instructor response fails to monitor the quality of the online course by the online instructor. None of the systems evaluate real-time quality of an online class.

There is a need in the area of online based educational courses to provide an improved system and method that will improve quality of the online classroom services to prevent the repeat of errors or problems in future online courses thereby resulting in refined “best practices” for the institution offering the online courses. None of the prior art discloses how to provide a real-time assessment to an online educational institution enabling that institution to make course adjustments before the online course ends.

There is also a constant need for an improved system and methods for evaluating the performance of an online instructor and to meet performance expectations and objectives of the educational institutions.

Still there is also another constant need for an improved method and system for adequately assessing the teaching performance of an online instructor during an online course provided by the educational institution.

Therefore, it is an object of the present invention to provide an improved method and system that the educational institutions providing numerous online courses may utilize to provide a high quality level learning environment by providing real-time assessment of an online course offering.

### SUMMARY OF THE INVENTION

The inventive online classroom quality control process and system (the system) measures and monitors the quality and quantity of instructions of a tutor and/or a teacher in an online classroom environment thereby consistently measuring and improving quality on the online classroom experience. The system of online classroom quality control monitors the interaction between an online instructor hired by an educational institution to teach the online class and online students and to determine quality of teaching. The method provides Claim 1 criteria and guidelines with desired expectations while the online class is being taught enabling the institution to make adjustments to the online class before the online class ends.

The duration is segmented into a plurality of sessions observing quantity and quality of the online class taught by the online instructor during the online class. The system determines quality and quantity of each session and compares the observed quality and quantity with the criteria and guidelines. The system then informs the educational institution about any offset between the criteria and guidelines provided by the educational institution and the results of the observation measured during at least at the end of each session. The system provides the institution with feedback and informs the educational institution to make adjustments before next session to ensure quality of ensuing sessions.

Alluding to the above, the system's goal is directed to improvement of the quality of the online classroom experience for their online students and to assist in the development of best practices for the educational institution to continuously improve the quality of the institution's educational offerings in order to graduate students and further improve the learning experience.

The system provides a tool for institutions to measure, maintain and improve online classroom quality control. The process provides information to the institution on a predetermined basis for use in monitoring online classroom quality on a more frequent basis, with both scientific data from the online classroom software system and classroom audits to review the online classroom operations.

An advantage of the present invention is to provide a system and method that use both scientific data/reports, along with the online classroom audits, and the online classroom quality control debrief report thereby to developing best practices for the institution's online classroom operations.

Another advantage of the present invention is to provide a system and method that improves the online student retention rate, unsuccessful rate (the number of online students that either fail or withdraw from an online class), online student satisfaction levels, and graduation rate (if applicable to the program and institution).

Another advantage of the present invention is to provide an improved system and method for evaluating the performance of an online instructor and to meet performance objectives provided by the educational institutions.

Still another advantage of the present invention is to provide an improved method and system that adequately assesses the teaching performance of an online instructor during of an online course provided by the educational institution in real-time enabling the institution to make course adjustments prior to the end of the online course, thereby improving the quality of the online course.

Still another advantage and objective of the present invention is to provide an improved method and system that the educational institutions may utilize to provide a high level learning environment mimicking and even exceeding quality and experience of a real classroom environment.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic view of an inventive online quality control process showing steps 1 through step 7;

FIG. 2 is a schematic view of the inventive online quality control process showing steps 8 through step 13;

FIG. 3 is a schematic view of the inventive online quality control process showing steps 14 through step 20;

FIG. 4 is a schematic view of the inventive online quality control process showing steps 20A through step 25; and

FIG. 5 illustrates Initial Quality Assessment Survey form of the present invention.

### DETAILED DESCRIPTION OF THE PREFERRED EMBODIMENT

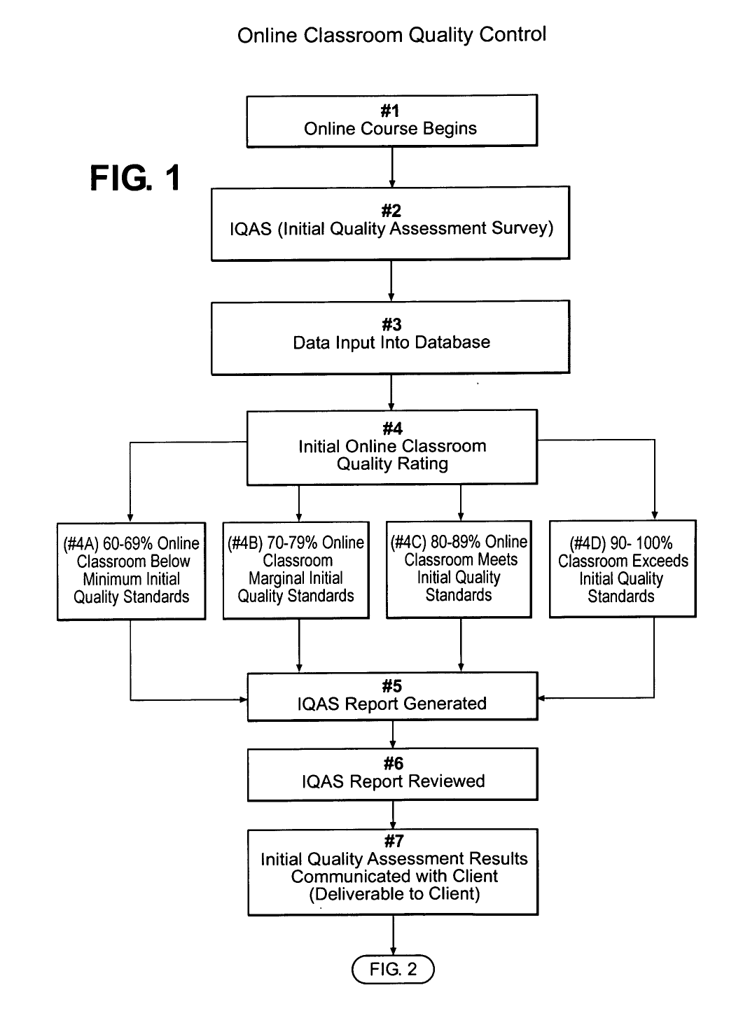

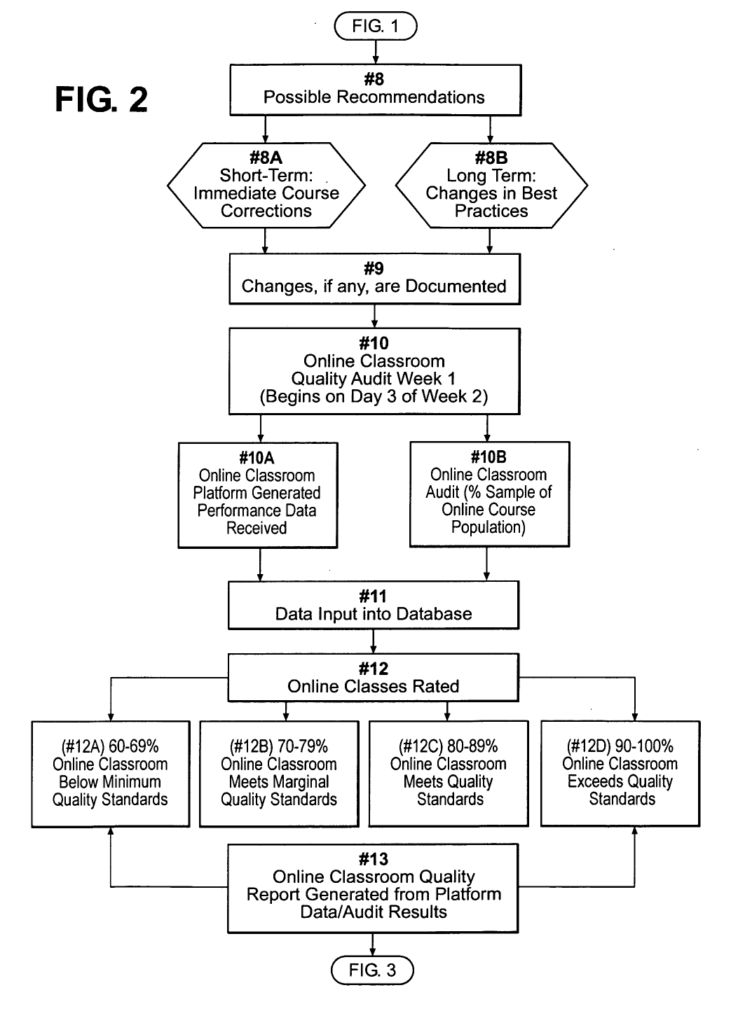

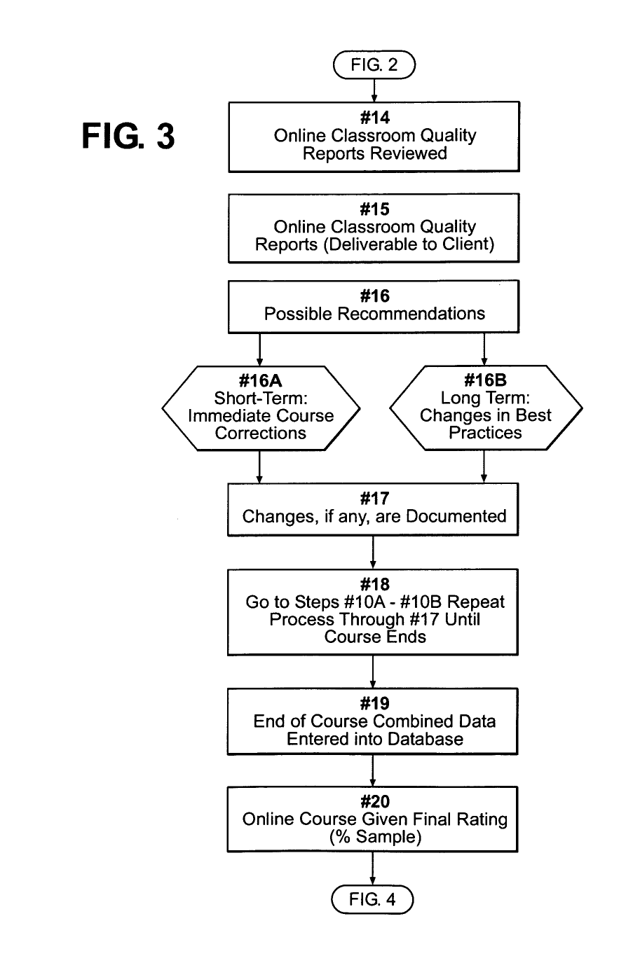

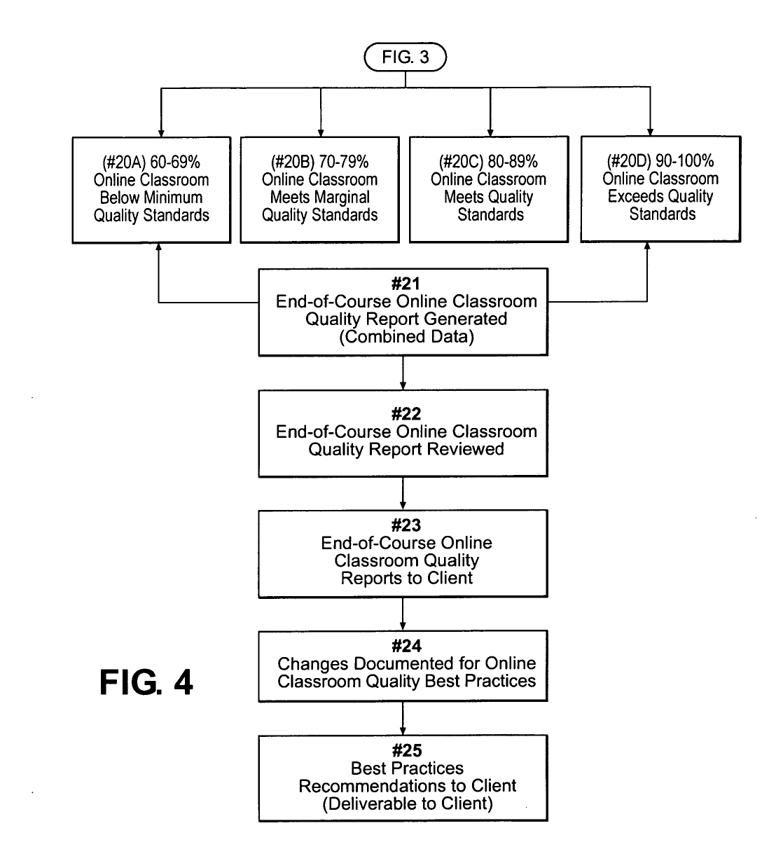

Referring to the Figures, an inventive online classroom quality control process and system (the system) is illustrated in FIGS. 1 through 4. As illustrated in FIGS. 1 through 4, the inventive concept requires numerous steps. The following step, i.e. step 1, provides the Online Course Begins. On a set date, the online classroom is made available to both the online students and the online instructor. The online class has officially started and the online instructor is expected to teach the online class as trained by the educational institution. The online students are expected to attend the educational institution. The educational institution is expected to have the online classroom prepared and set up for proper content. The online classroom platform is expected to be functioning properly. The college administration is expected to be responsive to the needs of the online students, online instructors, and platform providers. The beginning of the online class is crucial, in terms of the initial assessment/measurement of the level of the online classroom quality so that immediate changes to the online class and long-term changes.

The following step, i.e. step 2, begins the Initial Quality Assessment Survey (IQAS), which is comprised of the data collected in step 3, via online classroom audit, during week one, day three, of the online class. Step #3 presents Data Input Into Database. Online classroom audits are conducted using the Initial Quality Assessment Survey (IQAS) within a percentage sample of the online classroom population, to insure that the online classroom quality control process includes a qualitative component. This instrument is designed to assess the level of engagement, preparedness, professionalism, responsiveness, functionality, and other variables that the educational institution must provide in the online classroom in order to maintain quality.

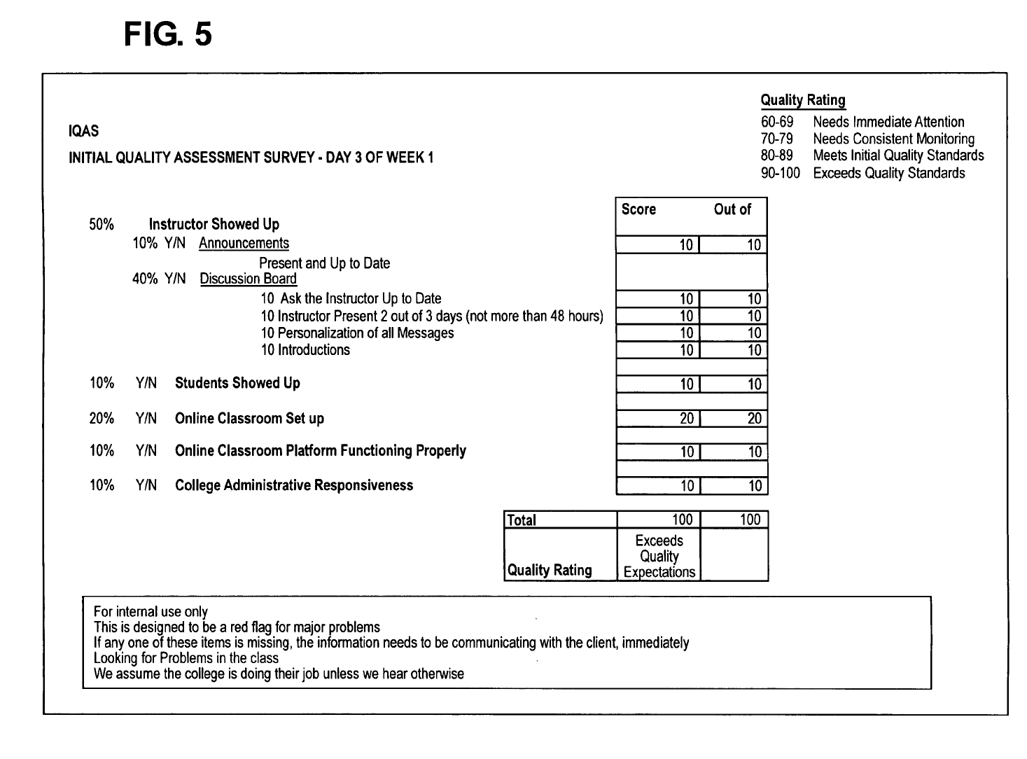

Online classroom audits via the IQAS to review and monitor the operations of the online classroom are a preliminary part to assessing, reporting, and communicating the quality level of the online classroom instruction and are conducted on a set basis, beginning with the first week of the online class and continuing through the official end of the online class, at predetermined intervals. The form represented in FIG. 5 is exemplary of the analysis that is performed while the online classroom instruction is continuing as will become more obvious below.

Step #4 includes an analysis of the IQAS to provide a report on the level of online classroom quality. Online classroom data collected from all the instruments referenced in Flow Chart 3 is input and assessed to compute the Initial online classroom quality rating. Step #5 provides an IQAS Report Generated from the IQAS results. Online classroom data collected from the instrument referenced in Flow Chart Step 3, is collected and tabulated via the IQAS for the first week of the online class, collected on day 3 of week one. This IQAS Report is generated for each online class to assess initial (first week) online classroom quality levels.

Step #5 provides the IQAS Reports Generated from IQAS Results by Auditor Online classroom data collected from the instrument referenced in Flow Chart Step 3 is collected and tabulated via the IQAS for the first week of the online class, collected on day 3 of week one. This IQAS Report is generated for each online class to assess initial (first week) online classroom quality levels. It should be understood by those of skill in the art that the initial quality assessment conducted in steps 2 through 5 may be performed at a remote location by accessing the online classroom via computer interface. It is not necessary to contact individuals at this point because the initial assessment focuses on those attributes identified in FIG. 5, such as, for example, online student participation, professor participation, timeliness of responses, etc. as will become more evident below.

Step #6 provides IQAS Reports Reviewed by Auditor The IQAS Report is generated for each online class and is used to assess online classroom quality levels. Auditor reviews the data related to each online class to assess initial online classroom quality levels. For example, online classroom announcements are posted and updated by the online are scheduled at predetermined intervals to simulate a conventional educational experience. If the online instructor's online classroom announcements are not updated and attended to on a regular basis, their instruction does not meet a minimum quality level. Therefore, the online educational experience is diminished. The IQAS assesses the initial rate of participation by the online instructor and online student, in addition to other factors determining the initial quality level of an online class. To improve the quality of the online educational experience in real time, an institution needs accurate, current information so it may take corrective action before the end of the online course, and thereby maintain or exceed the high quality levels. Furthermore, the initial quality assessment provides the educational institution the opportunity to make improvements to the online classroom experience early during the term, or in real time, by focusing on specific deficiencies identified by the IQAS report.

Step #7 provides the Initial Quality Assessment Results. (Deliverable to Educational institution). Auditor compiles and reviews the IQAS Reports, which are then summarized and forwarded to the educational institution, via online feedback from the computer network. The IQAS Report is used by the educational institution to review the initial online classroom quality level and to determine what, if any, immediate actions are required in order to maintain desired quality levels. Because this step is performed early during the term of the online class, changes necessary to the maintaining desired quality levels can be made immediately, if necessary.

Alluding to the above, Step #8 involves Auditor compiling and reviewing the IQAS Reports, which are then summarized and forwarded to the educational institution, via electronic media from the remote location. The IQAS Report is used by the educational institution/college to determine what, if any, of the following actions are required in order to maintain desired quality levels. For example, Step 8a provide for immediate Changes be implemented in the online classroom, while the current online classroom is still in session; or Step 8b provides no changes to the present online class/potential changes to online classroom best practices for the future online course delivery.

Step #9 Changes to immediately implement in the online classroom, while the current online classroom is still in session, or make no changes to the present online classroom/potential changes under Step 8B to the online classroom best practices for the future online course delivery are documented.

Step #10 Go to Step 3 and Repeat Process through Step 9. The Online Classroom platform generated performance data and online classroom audit information are input into the Auditor database on a predetermined basis. This process is repeated on a predetermined basis at a predetermined interval and continuing through the official end of the online class, or at set intervals as requested by the educational institution. The iterative nature of the present inventive quality control process provides a continuous improvement element to the online educational experience not presently available to even conventional educational institutions. The use of internet or equivalent electronic device facilitates the necessary continuous monitoring of the online classroom enabling presently unavailable continuous improvement of the online educational experience also enabling the real time quality improvement.

Step #11 covers Data Input into Auditor Database. Online classroom data generated from the online classroom platform system and the information collected from the online classroom quality audits for a specified percentage of the online classes running in a given term is input into the Auditor database for purposes of analyzing the data collected from the inputs to determine an online classroom quality rating for the online class for a specific week or at a certain, specified interval of the online class.

Step #12 covers Online Classes Rated. Online classroom data generated from the online classroom platform system and the information collected from the online classroom quality audits for a specified percentage of the online classes running in a given term is input into the Auditor database for purposes of analyzing the data collected from the inputs to determine an online classroom quality rating for the online class for a specific week or at a certain, specified interval of the online class. All of the data collected for a specified week or at specified intervals is processed in the Auditor database to produce a numerical rating of quality for the week or time period of the online class. Following are the numeric ratings available, along with a verbal explanation: 12A 60-69% Online Classroom Below Minimum Quality Standards, 12B 70-79% Online Classroom Meets Marginal Quality Standards, 12C 80-89% Online Classroom Meets Quality Standards, and 12D 90-100% Online Classroom Exceeds Quality Standards. These ratings are exemplary of the quantitative standards and monitoring of the online classroom. However, other quantitative standards are contemplated by the inventor for alternative online classroom experiences.

Step #13 covers Periodic Online Classroom Quality Report Generated from Platform Data/Audit Results. The Periodic Online Classroom Quality Report is generated from the Auditor database, based on the online classroom performance data and online classroom quality audit results that were input for the specified time interval. A numerical online classroom quality control rating is generated and incorporated into the Periodic Online Classroom Quality Report.

Step #14 covers Periodic Online Classroom Quality Reports Reviewed by Auditor. The Periodic Online Classroom Quality Reports are reviewed by Auditor for the respective online classes to determine what information should be communicated to the client and to further analyze and assess the level of online classroom quality that is observed.

Step #15 covers Periodic Online Classroom Quality Reports (Deliverable to Client). After a review of all of the periodic online classroom quality reports by Auditor, periodic online classroom quality reports are delivered to the client, as deemed necessary, appropriate, and/or as part of the client agreement. Step #16 covers Possible Recommendations. After a review of all of the periodic online classroom quality reports by Auditor, periodic online classroom quality reports are delivered to the client, as deemed necessary, when the quantitative standards set forth above are not in a satisfactory range. Where possible, Auditor will recommend online classroom improvements and/or changes in order to improve the quality of the online classroom experience.

Step #16(a) covers Short-Term: Immediate Course Corrections. Recommended online classroom quality improvements and/or changes to be made to the online classroom immediately, in order to improve the online classroom experience and improve the online classroom quality level. These changes may be to one online course, specifically, or to all online classes so as yield an improved online classroom quality level. For example, if the quantitative standard is not maintained due to poor online student participation, the online students will be prompted by the online institution to increase participation. Alternatively, if the online classroom instructor is not providing sufficient chat sessions the online institution will be advised to make a behavioral adjustment to then online instructors chat sessions.

Step #16(b) covers Long Term: Changes in Best Practices. Recommended online classroom quality improvements and/or changes to be made to the online classroom in the future, in order to improve the online classroom experience and improve the online classroom quality level. These changes may be incorporate on a large-scale to all online courses to yield an improved online classroom quality level. Furthermore, it is contemplated by the inventor that these long term corrections may be implemented before the term is over so that the corrections are in place prior to beginning the following and future terms.

Step #17 covers changes, if any, which are documented. Any desired changes (see steps 16a and 16b) by the client or recommended changes by Auditor to the client's online classroom are documented for future reference and possible implementation or best practices usage.

Step #18 covers Go to step number 10 and repeat process through #17 until the online course ends. Repeat the above process for each week or specified interval, as requested by the client, to review and assess the online classroom quality level. The repetitive or iterative nature of the subject inventive process enables the institution to continually enhance the online educational experience before the end of the online class.

Step #19 covers End of Course Combined Data Entered into Auditor Database. All of the data collected, starting with the IQAS in week one and including all subsequent information collected in the following weeks or specified intervals is entered into the Auditor database to produce a numerical rating of quality for the said online class to establish the quantitative performance.

Step #20 covers Online Course Final Rating. All of the data collected, starting with the IQAS in week one and including all subsequent information collected in the following weeks or specified intervals is processed in the Auditor database to produce a numerical or quantitative rating of quality for the online class. Following are the numeric ratings available, along with a verbal explanation: 20A 60-69% Online Classroom Below Minimum Quality Standards, 20B 70-79% Online Classroom Meets Marginal Quality Standards, 20C 80-89% Online Classroom Meets Quality Standards, 20D 90-100% Online Classroom Exceeds Quality Standards.

As represented in FIG. 5, qualitative evaluation of the online classroom is also used to determine quality standard of the online learning experience. Surveys of the online students and the professor are conducted periodically and/or at the end of the online class depending upon the needs of the institution.

Step #21 End-of-Course Online Classroom Quality Report Generated. The End-of-Course Online Classroom Quality Report is generated from the Auditor database, based on the IQAS conducted in week one and including all subsequent information collected in the following weeks or specified intervals and input and processed in the Auditor database to produce a numerical or quantitative rating of quality for the online class.

Step #22 covers End-of-Course Online Classroom Quality Report Reviewed by Auditor The End of Course Online Classroom Quality Reports are reviewed by Auditor for the respective online classes to determine what information should be communicated to the client and to further analyze and assess the level of online classroom quality that is observed.

Step #23 covers End-of-Course Online Classroom Quality Reports Delivered to Client. After a review of all of the end-of-course online classroom quality reports by Auditor, the end-of-course online classroom quality reports are delivered to the client, as deemed necessary, appropriate, and/or as part of the client agreement.

Step #24 covers Changes Documented for Online Classroom Quality Best Practices. After a review of all of the end-of-course online classroom quality reports by Auditor, end of course online classroom quality reports will result in Auditor recommendations for online classroom improvements and/or changes in order to improve the quality of the online classroom experience for the specific educational institution.

Step #25 covers Quarterly Best Practices Recommendations to Client (Deliverable to Client). Based on the information obtained via the online classroom quality control process described above, Auditor creates what it recommends as Best Practices for overall online classroom quality control, specific to the each educational institution/client. The Quarterly Best Practices recommendations are provided in a document to the educational institution for future implementation and reference.

Alluding to the above, the purpose of the present invention is to define a standardized process for measuring the online classroom quality and to provide real-time online classroom quality feedback information to the educational institution that results in consistently high quality online classroom experience. The main component/steps of the inventive system include but are not limited to the Initial Quality Assessment Survey (IQAS) and related IQAS report, Online Classroom Platform Generated Data, Online Classroom Audits that provide real-time, online classroom performance data enabling improvement to the online classroom while the online classroom is still in session. One objective of the present invention is to collect regular, consistent information from the online classroom that is then collected, analyzed, internally reviewed and communicated to the client in order to measure and communicate online classroom quality levels. An additional goal of the inventive system is to define a standardized process for measuring the online classroom quality and to provide real-time online classroom quality feedback information to the educational institution that results in consistently high quality online classroom experience.

A further goal of the inventive system is to improve the quality of the online classroom experience and to assist in the development of best practices for use by the educational institution, in order to maintain consistently high quality in the online classroom in the future. The system provides numerous advantages over the prior art systems. One of the advantages of the present invention is to provide a system and method that uses both scientific data/reports generated by the online classroom platform generated performance data, along with the Initial Quality Assessment Survey (IQAS) and weekly online classroom audit and related reports thereby to develop best practices for the institution's online classroom operations. Another advantage of the present invention is to provide a system and a method that improves the online classroom quality level so as to favorably impact the educational institution's online student retention rate, unsuccessful rate (the number of online students that fail or withdraw from a class), online student satisfaction levels, and graduation rate (if applicable to the program and educational institution). Still another advantage and objective of the present invention is to provide an improved method and system that the educational institution may utilize to provide a high level online learning environment that exceeds the quality and learning experience of other institutions not practicing the present inventive method.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of continuously improving an online course taught by an educational institution over a computer generated medium to a plurality of locations; comprising the steps of:
establishing a minimum criteria used to determine the quality of the online course taught through the computer generated medium;
monitoring online course sessions from a remote location through the computer generated medium at predetermined periodic intervals;
preparing electronic reports at the remote location and providing the electronic reports to the educational institution during the online course thereby enabling the educational institution to make real time adjustments to the online course before the online course ends for improving the quality of the online course.

2. The method set forth in claim 1, wherein said step of establishing minimum criteria for determining quality of the online course taught through the computer generated medium is further defined by establishing qualitative and quantitative criteria.

3. The method set forth in claim 2, further including the step of monitoring qualitative and quantitative criteria at predetermined intervals.

4. The method set forth in claim 1, wherein said step of monitoring online course sessions at periodic intervals is further defined by monitoring the online course session after each online course session concludes.

5. The method set forth in claim 4, further including the step of providing an electronic report establishing qualitative and quantitative performance before a subsequent online course session begins.

6. The method set forth in claim 2, wherein the quantitative criteria includes professor log in amount, online student log in amount, student participation, student participation, or professor participation.

7. The method set forth in claim 2, wherein the qualitative criteria includes online student pass rate, online student grades, online student survey results, or professor survey results.

8. The method set forth in claim 7, wherein the effectiveness of the steps set forth in claim 1 is determined by the qualitative results.

9. The method set forth in claim 1, wherein the step of establishing a minimum criteria includes establishing a level of minimum initial quality standards, meeting marginal initial quality standards, meeting initial quality standards, and exceeding initial quality standards.

10. The step set forth in claim 1, further including the step of iteratively monitoring online course sessions from a remote location through the computer generated medium and iteratively preparing electronic reports at the remote location and providing iterative electronic reports to the educational institution during the online course thereby enabling the educational institution to improve the quality of the online course before the online course ends.
